(19) United States
(12) Patent Application Publication
(10) Pub. No.: US 2025/0316813 A1
(43) Pub. Date: Oct. 9, 2025

(54) HOT-FORMED AND PRESS-HARDENED BATTERY TRAY

(71) Applicant: BENTELER AUTOMOBILTECHNIK GMBH, Paderborn (DE)

(72) Inventors: Thomas BRUEGGEMANN, Verl (DE); Christian BUSE, Lichtenau (DE); Conrad FRISCHKORN, Paderborn (DE); Christian HANDING, Langenberg (DE)

(21) Appl. No.: 19/171,351

(22) Filed: Apr. 7, 2025

(30) Foreign Application Priority Data
Apr. 8, 2024 (EP) 24169014.8

(51) Int. Cl. H01M 50/207; H01M 50/224; H01M 50/233; H01M 50/249

(52) U.S. Cl. CPC H01M 50/207; H01M 50/224; H01M 50/233; H01M 50/249; H01M 2220/20

(57) ABSTRACT

The present disclosure relates to a battery tray for an electric vehicle, manufactured as a hot-formed and press-hardened component from a sheet steel blank, having a base and side walls rising from the base with a flange running around the top of the battery tray and projecting outwards, characterized in that the side walls run on the longitudinal sides of the battery tray and the side walls run on the transverse sides of the battery tray at an angle of greater than 1° relative to a vertical, and in a respective corner region the base of the battery tray merges into a curved surface in such a way that a transition radius of the curved surface to a transverse side wall is formed and a transition radius of the curved surface to a longitudinal side wall is formed.

### RELATED APPLICATIONS

The present application claims priority of European Application Number 24169014.8 filed Apr. 8, 2024, the disclosure of which is hereby incorporated by reference herein in its entirety.

### FIELD

The present disclosure relates to a hot-formed and press-hardened battery tray for an electric vehicle.

### BACKGROUND

Battery trays are used for motor vehicles, in electromobility. Such battery trays have a battery tray for accommodating drive batteries. The battery tray is closed with a lid. Such a battery tray is located in the underfloor region of a motor vehicle. The battery tray extends over a large part of the underfloor region, in the passenger compartment. Long sides of the battery tray are formed on the sides in the region of the sills. Transverse sides are formed at the head and rear. The transverse sides are shorter than the long sides.

Furthermore, a battery housing for an electric motor-driven vehicle is described in DE 10 2016 116 729 B4, which is manufactured using a deep-drawing process.

### SUMMARY

The object of the present disclosure is a battery tray which is able to be manufactured in a simplified manner and is optimized with regard to the internal receiving space for receiving batteries and is improved in its crash resistance in the case of a motor vehicle.

The battery tray is provided for an electric vehicle or electric motor vehicle. A battery tray is made from a sheet steel blank as a hot-formed and press-hardened component. The sheet steel blank is made of a hardenable steel alloy, for example, 22MnB5. For hot forming and press hardening, the blank is able to, for example, have a scale or corrosion protection layer. This is able to be aluminum-silicon based or zinc based or a combination of both. The material thickness is between 0.8 mm and 2.5 mm, between 1.0 mm and 2.2 mm, or between 0.8 mm and 1.5 mm. For hot forming, the material is first heated to above the austenitizing temperature, i.e., to over 900° C., then hot formed in a press and then cooled or quench hardened. In this case, tensile strengths Rm greater than 1000 MPa, greater than 1350 MPa, is able to be produced at least in sections, over the entire surface of the entire battery tray.

The battery tray itself has a tray-shaped housing. A base is provided for this purpose. The base is level or flat. However, various reinforcing beads or cross braces are able to be incorporated into the base itself. These reinforcement structures are able to increase the rigidity of the base. However, the reinforcement structures are also able to increase crash rigidity. Also, beads are able to be introduced into the base so that, when further coupled with another sheet of the base, a cooling channel structure is created, such that when a cooling medium is passed through, the base is able to be provided as a cooling base for the batteries arranged in the battery tray.

Side walls extend from the base or rise in relation to the vertical direction of the vehicle. In an upper region of the side walls there is a flange that runs around the battery tray and projects outwards. This flange serves both to stiffen the body and to close the battery tray with a lid.

The battery tray is characterized in that the side walls on the long sides, hereinafter also referred to as the longitudinal side wall, of the battery tray and the side walls on the transverse sides, i.e., the head and rear sides, hereinafter also referred to as the transverse side walls, are oriented at an angle of greater than 1° to a vertical or to the vertical direction of the motor vehicle when the battery tray is installed. In at least one embodiment of the present disclosure, the angle of the longitudinal side walls is greater than the angle of the transverse side walls. This results in an optimum combination of manufacturability in the deep drawing or press forming process and the available space for accommodating batteries. Furthermore, the installation space is optimized for electrical connections of the battery modules within the battery tray as well as the connection of a cooling system, which is also able to be designed to pass through or penetrate the battery tray. Furthermore, improved crash characteristics are achieved in frontal and side crashes because at least one of the walls is steeper, i.e., has a lower inclination to a vertical line. In at least one embodiment, these are always two opposite walls that have the same inclination.

In at least one embodiment of the present disclosure, the side walls run in the transverse direction of the vehicle, extend from a left to a right side of the vehicle, are steeper, i.e., have a lower inclination to a vertical. The side walls that run in the longitudinal direction of the vehicle, i.e., from the front of the vehicle to the rear of the vehicle, are less steep in relation to the cross-section, and, for example, are at a greater angle to the vertical than the side walls that run transversely to the vehicle.

The angle relative to the vertical of the transverse side walls is 1° to 6°. The angle is 2° to 6°, or 3° to 6°. The angle of the longitudinal side walls relative to the vertical is 8° to 20°, or 13° to 20°.

Due to the different angles of the transverse side walls and the longitudinal side walls, the corners or corner regions in the respective transition region from the transverse side wall to the longitudinal side wall are asymmetrically designed.

In at least one embodiment of the present disclosure, the corners or corner regions are arranged or formed offset outwards. Outward refers to the interior of the battery tray. Compared to the transverse side wall and/or longitudinal side wall, a respective corner region is then offset outwards, at least in sections, in relation to the longitudinal and/or transverse direction of the motor vehicle. This means that at least part of the corner region protrudes outwards beyond the transverse side wall or the longitudinal side wall. This in turn offers various advantages. On the one hand, there is an optimization of the forming process, such as the local stretching levels during the production of the corners are thereby reduced, so that no breaking or cracking occurs.

Furthermore, the installation space available in the battery tray is optimized by the outwardly shaped corners or corner regions. Furthermore, there is improved crash performance because the corner region is stiffened by the outward shaping. In addition, the corner region protrudes and is able to mitigate an initial impact in the event of a crash, following the principle of a crash box. A further advantage of the outwardly shaped corner is that a crash frame attached to the outside or inside of the respective side walls is able to be shortened in longitudinal sections, resulting in material and weight savings. In at least one embodiment of the present disclosure, a reinforcement profile is able to be attached to the outside and/or inside of the side wall. A hollow profile is then created in the respective cross-section. However, the reinforcement profile does not have to run along longitudinal sections over the entire side wall. The reinforcement profile then runs along longitudinal sections only up to the beginning of the corner region, but is also able to extend beyond.

Furthermore, the corner regions are designed according to the present disclosure in such a way that a curved plane or surface rises from the base plane with a continuously increasing curvature. The plane is curved around a 2-point line, wherein the 2-point line is located in the X-Y-plane, i.e., in the plane spanned by the transverse and longitudinal directions of the vehicle. The curvature of a corner plane is then formed around this straight line or 2-point line. The curved surface is therefore two- dimensionally curved but not three-dimensional. In the context of the present disclosure, this means that the plane has a partially cylindrical curvature, but not a spherical curvature in sections. At the respective transition of the curved surface to the transverse side wall or longitudinal side wall, a radius is then formed with which the curved surface merges into the respective side wall.

The bottom of the battery tray thus rises into the corner region at the transition with the curved surface or plane. This curved surface or plane follows a section-wise external surface of a cylinder.

The radius is thus able to change. In at least one embodiment of the present disclosure, the curvature increases, i.e. the radius becomes increasingly smaller. Starting from the base, there is initially a slight curvature. The further the curvature enters the outer corner, the smaller the radius becomes and the stronger the curvature becomes. Thus, a partially cylindrical contour is formed in sections. This means that the curved surface runs in sections as the external surface of a cylinder.

The curved surface extends, relative to the vertical direction of the motor vehicle, over a maximum of 85% of the height of the battery tray, or over approximately 50% to 75% of the height of the battery tray. The remaining height section of the battery tray or side walls is then designed as a transitional radius from the transverse side wall to the longitudinal side wall, wherein the radius is able to change. The height of the battery tray is more than 50 mm, more than 80 mm, or more than 100 mm, but not more than 150 mm.

The curved surface has a height and a width in a cross-section. The cross-sectional surface is in the vertical direction of the vehicle. The height thus extends in the vertical direction of force. The width lies in the plane spanned by the transverse direction and the longitudinal direction of the vehicle. The ratio of height to width of the curved surface is 0.5 to 1, or 0.65 to 0.85. This ratio of the curved surface is present at a 45° angle of the corner. This means in plan view, it is exactly in the middle of the corner and is shown below in FIG. 3 and FIG. 9. The above ratio means that the width has a larger value than the height.

In at least one embodiment of the present disclosure, the outer circumferential flange is able to have a circumferential rectangular contour in plan view, i.e., viewed from above in the vertical direction of the motor vehicle. This means that the battery tray is able to be closed with a lid and the lid would then also have a rectangular contour. However, the flange is also able to have a constant width. In at least one embodiment of the present disclosure, with corner regions facing outwards, the flange does not have a rectangular contour in plan view, but rather the flange follows the corner regions facing outwards.

Furthermore, the battery tray is able to have various beads or reinforcement structures. These are able to, for example, serve as an underride guard. Accordingly, beads would be designed downwards in the vertical direction of the vehicle when the battery tray is installed, i.e., they would protrude or project downwards from the bottom of the battery tray.

Furthermore, openings for electrical connections and/or coolant lines are able to be provided, for example, in the side walls, in the longitudinal side walls. These are able to be introduced, for example, after hot forming and press hardening by means of laser cutting or when the blank is prepared. The base of the battery tray is able to further have a cooling channel structure. This is able to be embossed in one piece with a beading and then closed with a strike plate.

Furthermore, a lid with which the battery tray is closed and is able to also have a cooling channel structure. In this case, the present disclosure would then include a battery tray assembly including a battery tray and a closing lid. The lid is then placed on the flange using a sealant and joined, for example, screwed.

### BRIEF DESCRIPTION OF THE DRAWINGS

Further advantages, features, properties, and aspects of the present disclosure are the subject matter of the following description. Various embodiments are shown as figures. These simplify the understanding of the present disclosure. The individual exemplary embodiments are able to be combined with each other as desired without departing from the scope of the present disclosure, such as:

FIG. 1 shows a battery tray according to at least one embodiment of the present disclosure in perspective view,

FIG. 2 shows the perspective view from below according to at least one embodiment of the present disclosure,

FIG. 3 shows a plan view of the battery tray according to at least one embodiment of the present disclosure,

FIG. 4 shows the battery tray according to at least one embodiment of the present disclosure in a side view,

FIG. 5 shows the section line V-V to FIG. 3 according to at least one embodiment of the present disclosure,

FIG. 6 shows the section line VI-VI to FIG. 3 according to at least one embodiment of the present disclosure,

FIG. 7 shows a horizontal section through a corner region according to at least one embodiment of the present disclosure,

FIG. 8 shows a horizontal section through a corner region according to at least one embodiment of the present disclosure, and

FIG. 9 shows a longitudinal sectional view through a corner region according to the section line IX-IX of FIG. 3 according to at least one embodiment of the present disclosure.

### DETAILED DESCRIPTION

In the figures, the same reference numerals are used for same or similar components, although a repeated illustration or description is omitted for reasons of simplicity.

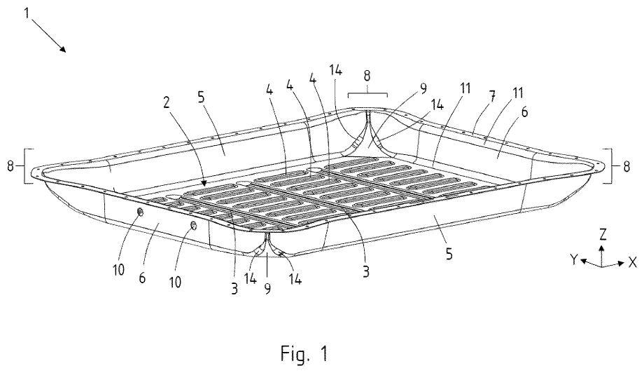

FIG. 1 shows a battery tray 1 according to the present disclosure in perspective view. The battery tray 1 has a base 2. The base 2 extends in a plane in the motor vehicle longitudinal direction X and motor vehicle transverse direction Y. Various stiffening geometries are formed in the base 2. For example, cross struts 3 are designed in the form of beads 4. These are formed downwards relative to the vertical direction Z of the motor vehicle. Furthermore, further stiffening beads 4 are embossed. These protrude into the interior space of the battery tray 1. Side walls in the form of two longitudinal side walls 5 extend from the floor 2. The longitudinal side walls 5 are oriented in the longitudinal direction X of the motor vehicle. In addition, there are two transverse side walls 6. The transverse side walls 6 are arranged at the front and rear with respect to the longitudinal direction X of the vehicle and themselves run in the transverse direction Y of the vehicle. On the upper edge of the side walls, a circumferential flange 7 is formed around the outside and projects outwards. The flange 7 itself lies in a plane spanned by the transverse and longitudinal directions X, Y of the motor vehicle. The longitudinal and transverse side walls 5, 6 are each connected to one another via a corner region 8. A curved surface 9 extending from the base 2 is formed in the corner region 8. The surface itself is a two-dimensional curved surface 9 and is cylindrical in sections, but with a varying radius. The curved surface 9 thus follows the course of the external surface of a cylinder. The curved surface 9 does not extend over the entire height of the battery tray 1, but over less than 85% of the height. Furthermore, openings 10 are able to be provided in the side walls for the passage of cooling channels and/or electrical connections. The longitudinal side walls 5 and transverse side walls 6 each transition with a transition radius 11 from the base 2 into the side wall and again from the side wall into the flange 7.

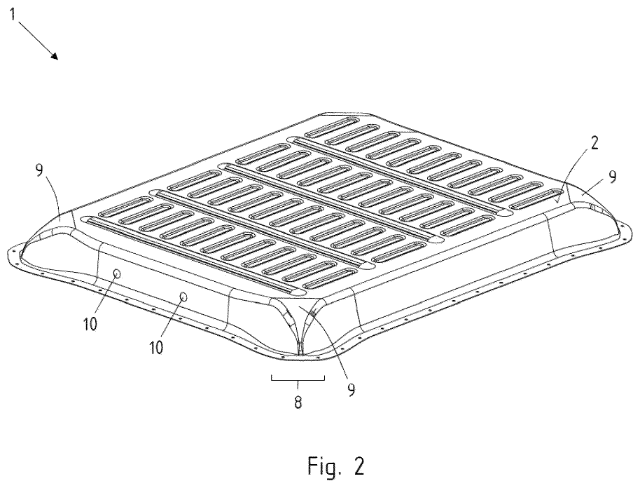

FIG. 2 shows the perspective view from below, and clearly shows that the respective curved surface 9 transitions from the plane of the base 2 in the corner regions 8.

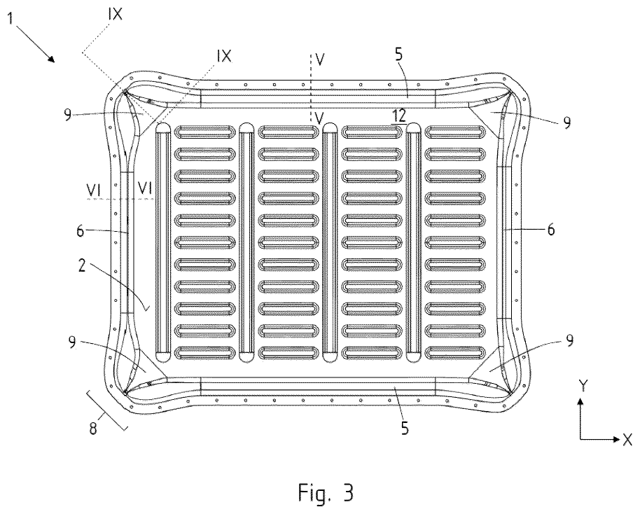

FIG. 3 shows a plan view of the battery tray 1 according to the present disclosure, and clearly shows that the respective corner regions 8 are offset outwards with respect to an interior space 12 of the battery tray 1, or offset outwards with respect to the longitudinal sides or transverse sides.

FIG. 4 shows the battery tray 1 according to the present disclosure in a side view, and clearly shows that the curved surface 9 does not extend over the entire height 13, but only over a part of less than 85%. Above the curved surface, relative to the motor vehicle vertical direction Z, the transverse side wall 6 and longitudinal side wall 5 are then connected via a radius 14 in the X-Y plane. The transition from the longitudinal side wall 5 to the curved surface 9 and from the curved surface 9 to the transverse side wall 6 is each formed with a transition radius 14.

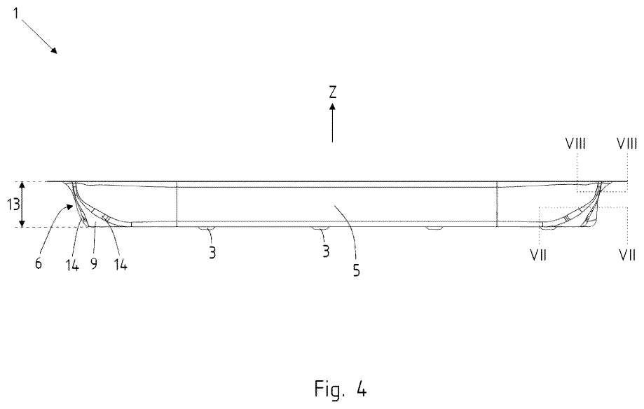

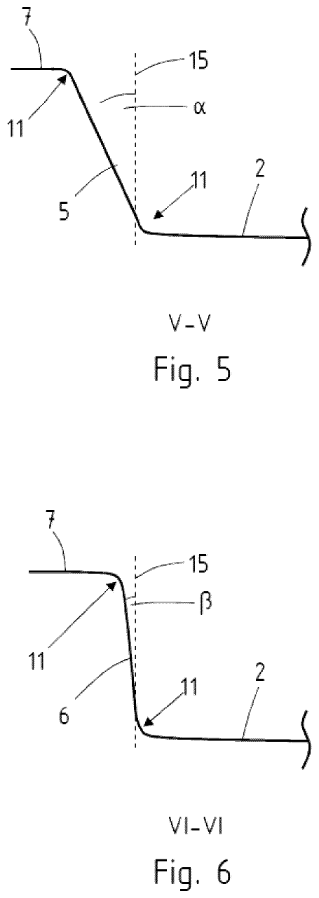

FIG. 5 and FIG. 6 show section lines V-V and VI-VI from FIG. 3. The feature according to the present disclosure is able to be seen, according to which the angle α15 of the longitudinal side wall 5 relative to a vertical is larger, for example, twice as large as the angle β 16 of the transverse side wall 6. In at least one embodiment of the present disclosure, the angle a has an angular range between 8° and 20°, 13° to 20°, whereas the angle β has an angular range between 1° and 6°, or between 3° and 6°.

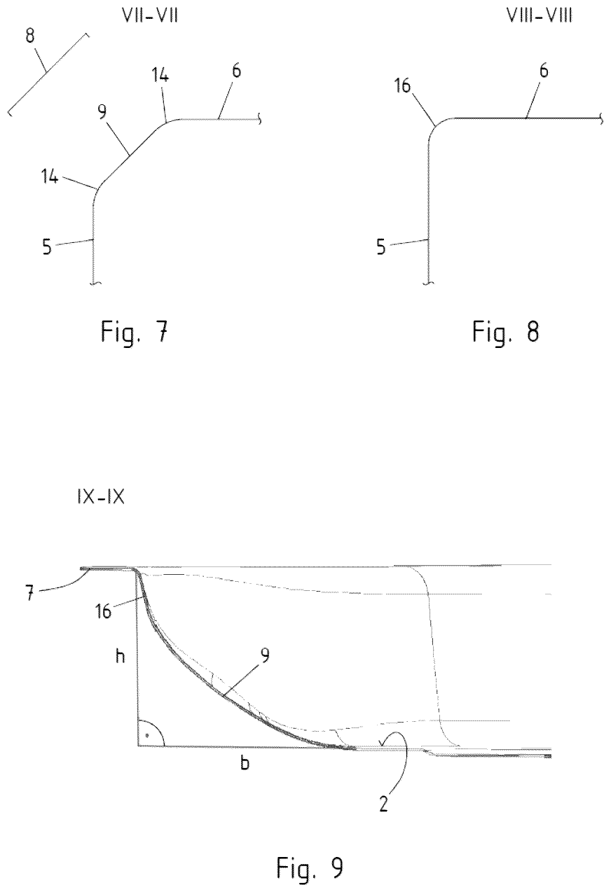

FIG. 7 shows a cross-sectional view along section line VII-VII of FIG. 4 in plan view, and clearly shows that the curved surface 9 of the corner region 8 merges with a transition radius 14 into the transverse side wall 6 or the longitudinal side wall 5.

FIG. 8 shows a cross-sectional view along section line VIII-VIII from FIG. 4, and clearly shows that in an upper region relative to the vertical direction Z, the transverse side wall 6 merges into the longitudinal side wall 5 with a radius 16. The curved surface 9 has thus already run out according to the section line of FIG. 8.

FIG. 9 shows a longitudinal sectional view through a corner region 8 according to the section line IX-IX in FIG. 3. The curved surface 9 rises from the base plane and then merges over the height 13 at the upper edge into the outwardly projecting flange 7. The ratio of height h to width b of this curved surface 9 is 0.5 to 1, or 0.65 to 0.85.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-12. (canceled)

13. A battery tray for an electric vehicle, the battery tray being a hot-formed and press-hardened component manufactured from a sheet steel blank, the battery tray comprising:
a base; and
side walls rising from the base with a flange running around a top of the battery tray, and the flange projecting outwards, wherein
the side walls comprise:
longitudinal side walls that run on longitudinal sides of the battery tray at a first angle of greater than 1° relative to a vertical, and
transverse side walls that run on transverse sides of the battery tray at a second angle of greater than 1° relative to the vertical, and
in a respective corner region where a respective longitudinal side wall of the longitudinal side walls is connected to a respective transverse side wall of the transverse side walls, the base of the battery tray merges into a curved surface in such a way that a transition radius of the curved surface to the respective transverse side wall is formed and a transition radius of the curved surface to the respective longitudinal side wall is formed.

14. The battery tray according to claim 13, wherein at least one of
the second angle of the transverse side walls relative to the vertical is 1° to 6°, or
the first angle of the longitudinal side walls relative to the vertical is 8° to 20°.

15. The battery tray according to claim 13, wherein the respective corner region is offset outwards from the respective transverse side wall and the respective longitudinal side wall, with respect to an interior of the battery tray.

16. The battery tray according to claim 1, wherein the first angle of the longitudinal side walls is greater than the second angle of the transverse side walls by at least two times.

17. The battery tray according to claim 1, wherein the curved surface has a cylindrical contour in sections with a variable radius.

18. The battery tray according to claim 1, wherein the curved surface extends from the base of the battery tray over a maximum of 85% of a height of the battery tray.

19. The battery tray according to claim 1, wherein the flange has a rectangular contour in a plan view, such that the battery tray is closable with a lid.

20. The battery tray according to claim 1, further comprising a reinforcing profile coupled to the battery tray in longitudinal sections on at least one respective side wall of the side walls.

21. The battery tray according to claim 20, wherein the reinforcing profile forms, together with the respective side wall, a hollow profile in cross section.

22. The battery tray according to claim 13, having a tensile strength Rm greater than 1000 MPa.

23. The battery tray according to claim 13, wherein a ratio of height to width of the curved surface is between 0.5 and 1.

24. The battery tray according to claim 13, wherein the flange has a constant width.

25. The battery tray according to claim 13, wherein at least one of
the second angle of the transverse side walls relative to the vertical is 3° to 6°, or
the first angle of the longitudinal side walls relative to the vertical is 13° to 20°.

26. The battery tray according to claim 13, wherein the curved surface extends from the base of the battery tray over 50% to 75% of a height of the battery tray.

27. The battery tray according to claim 13, wherein the curved surface extends from the base of the battery tray over 50% to 65% of a height of the battery tray.

28. The battery tray according to claim 13, further comprising a reinforcing profile coupled to the battery tray in the corner region.

29. The battery tray according to claim 21, further comprising:
reinforcing elements in the hollow profile.

30. The battery tray according to claim 13 having a tensile strength Rm greater than 1350 MPa.

31. The battery tray according to claim 13, wherein a ratio of height to width of the curved surface is between 0.65 and 0.85.
